(19) United States
(12) Patent Application Publication
(10) Pub. No.: US 2015/0348200 A1
(43) Pub. Date: Dec. 3, 2015

(54) SYSTEMS AND METHODS FOR FACILITATING COMMUNICATION AND INVESTMENT

(71) Applicants: Christopher T. Fair, Atlanta, GA (US); Greg Downey, Atlanta, GA (US)

(72) Inventors: Christopher T. Fair, Atlanta, GA (US); Greg Downey, Atlanta, GA (US)

(21) Appl. No.: 14/729,863

(22) Filed: Jun. 3, 2015

Related U.S. Application Data
(60) Provisional application No. 62/006,937, filed on Jun. 3, 2014.

(51) Int. Cl. G06Q 40/06

(52) U.S. Cl. CPC G06Q 40/06

(57) ABSTRACT

Systems, methods and techniques for facilitating communication and investment between prescreened investors and businesses seeking capital. The computer-aided system and method comprise a secure platform through which investors and businesses can interact. Business data is made accessible to the appropriate users, and investors can browse the same while remaining anonymous. Additionally, the system and method can categorize and sort businesses into targeted subsets pursuant to investor-defined parameters, thereby enabling investors to focus on and research a smaller group of businesses. The facilitating communication and investment system and method hereof further enables investors to contact targeted businesses directly through the secure platform to facilitate communication therebetween.

### PRIORITY CLAIM

This application is related to and claims the priority benefit of U.S. Provisional Application Ser. No. 62/006,937 to Fair et al., filed Jun. 3, 2014. The content of the aforementioned application is hereby expressly incorporated herein by reference in its entirety into this disclosure.

### BACKGROUND

Small businesses commonly have a need for fundraising to meet cash flow obligations or to expand their businesses Likewise, entrepreneurs with new ventures or product ideas need capital to start-up the business and/or develop the idea. (For the sake of simplicity, the term “small business” as used henceforth shall mean and include entrepreneurs as well as small businesses.) The traditional avenues through which small businesses can access capital funding typically include banks, friends and neighbors, and venture capitalists. These sources are limited, however, because they do not open up investing opportunities to more than a handful of individuals. Indeed, most small businesses do not have the time or resources to access a wide variety of potential investors, nor do they have the means to locate viable potential investors out of an investor pool and subsequently cultivate meaningful relationships with such investors once identified.

Similarly, investors such as venture capitalists, family offices and investment firms are constantly striving to identify and invest in new ideas and small businesses with potential. Such investors face difficulties correlative to those facing the small businesses—for example, there are countless small businesses looking for capital and it is a daunting task to sift through all such available investment opportunities to identify appropriate candidates. Furthermore, once candidates are identified, researching and validating the viability of new ideas and/or small businesses is a time-consuming and tedious process.

Crowdfunding is a relatively new phenomenon that has arisen as an alternative to conventional funding channels. The term “crowdfunding” generally refers to websites that post information for business ventures and charitable causes in need of funding. Through these websites, a company can achieve broad exposure and request funding in return for selling small amounts of equity to the investors. Accordingly, through crowdfunding a business or individual can finance a project or venture in a variety of ways—either by receiving and leveraging small contributions by many parties or in a more traditional sense by accepting a larger contribution from a single investor.

However, there are downsides to this type of funding as well. While a company can easily gain widespread exposure via crowdfunding sites, it is increasingly difficult for a company to differentiate itself from others who are promoting themselves through the same channels. Furthermore, the Internet is impersonal and statements/claims posted on crowdfunding sites need not be supported and/or have prior validation. Accordingly, not only must a potential investor sift through a myriad of companies/business ventures to identify those that may be a proper fit industry/topic-wise, but there is also a substantial risk that any information posted on the Internet regarding the company and/or business offering is not accurate. In other words, anyone can post to crowdfunding websites and it is impossible to know, on the face of these websites, whether or not such business ventures (and investors for that matter) are legitimate without the parties investing additional time and resources into research.

### BRIEF SUMMARY

In at least one exemplary embodiment of an investment and communication facilitation system of the present disclosure, the system comprises a platform and at least one input device in communication with the platform. The platform may comprise memory and be coupled with at least one server, the at least one server comprising at least one application capable of interacting with data stored at least partially in the memory of the platform. Additionally, each of the at least one input devices may be configured to receive data from a user. One or more of the applications is configured to interact with the stored data, categorize a plurality of users into at least two subsets pursuant to at least one attribute, evaluate the subsets against a set of parameters, and identify a targeted subset that satisfies the set of parameters. In at least one embodiment, each of the plurality of users is either an investor or a business seeking capital investment.

In yet another embodiment, one or more of the at least one applications is configured to evaluate each of the plurality of users against a set of criteria pursuant to a pass/fail standard and a user failing to satisfy the pass/fail standard results in denial of access to the platform for such user. In at least one embodiment of the aforementioned, the user being evaluated may comprise a business seeking capital investment and the set of criteria may comprise a due diligence checklist.

In those embodiments where the system comprises at least one input device that is coupled, or in communication, with the platform, the input device may be usable to receive data from the users and may be coupled or in communication with the platform via a communication link. Additionally or alternatively, the platform may comprise an exclusive crowdfunding platform. In at least one exemplary embodiment, the investment and communication facilitation system further comprises at least one user interface in communication with the platform. The at least one user interface may be configured to access and display the data stored at least partially in the memory of the platform. Additionally, one or more of the least one applications of the system may comprise tools usable to create and publish content accessible by a user through the platform. Such content may comprise and include text, images, audio files, video files, interactivity, and/or external links.

In an exemplary embodiment of a method for facilitating communication and investment between two or more parties of the present disclosure, the method comprises the steps of: providing a platform comprising memory coupled with at least one server, the at least one server comprising at least one application capable of interacting with data stored at least partially in the memory of the platform, and at least one input device in communication with the platform, each of the at least one input devices configured to receive data from a user, wherein one or more of the applications is configured to categorize a plurality of users into at least two subsets pursuant to at least one attribute, evaluate the subsets against a set of parameters, and identify a targeted subset that satisfies the set of parameters; receiving, on the platform, a first set of data from a plurality of users seeking investment and a second set of parameter data from at least one user seeking to invest; routing the first set of data and the second set of parameter data to at least one storage server in communication with the platform for storage thereon; categorizing the plurality of users seeking investment into one or more subsets based on the first set of data through operation of at least one application of the server; identifying at least one subset of users seeking investment that satisfies the second set of parameter data; and making content associated with each of the users seeking investment in the identified subset available via the platform to the user seeking to invest. In at least one embodiment, the first set of data comprises attribute data from each of the users seeking investment. Additionally or alternatively, in yet another embodiment, the content may comprise attribute data associated with each of the users seeking investment in the identified subset.

In at least one exemplary embodiment, the method may further comprise the steps of identifying a targeted user within the identified subset and facilitating communication between the targeted user and the user seeking to invest through a secure module of the platform. Such communication between the targeted user and the at least one user seeking to invest may be direct. The method disclosed herein may also further comprise the steps of executing an investment agreement between the targeted user and the at least one user seeking to invest and/or evaluating each of the users seeking investment and the at least one user seeking to invest against at least one set of prescreening criteria through operation of at least one application of the server. In still another embodiment, the user seeking to invest may comprise at least a first user seeking to invest and a second user seeking to invest. Furthermore, the step of executing an investment agreement between the targeted user and the at least one user seeking to invest via the platform may additionally comprise executing a first agreement between the targeted user and a first user seeking to invest and executing a second agreement between the targeted user and the second user seeking to invest.

In yet another embodiment, the method may further comprise the step of using an application of the server to create and publish content for each of the users seeking investment, wherein the content is selected from a group consisting of a personalized home page, promotional materials, and business documentation. The platform may also be configured to withhold the identity of the at least one user seeking to invest with respect to the users seeking investment. In at least one embodiment, the at least one user seeking to invest is anonymous to the users seeking investment unless and until the user seeking to invest chooses to disclose its identity.

In an exemplary embodiment of computer-readable media of the present disclosure, one or more computer-readable media is disclosed, the computer-readable media having computer-executable instructions which, when executed, perform steps comprising receiving a first set of data from a plurality of entities seeking investment and a second set of data from a user seeking to invest; routing the first and second sets of data to at least one storage server for storage thereon; categorizing, by a processor, the plurality of entities into subsets based on the first set of data; identifying, by a processor, at least one subset of entities that satisfies the second set of data; and making content associated with each of the users seeking investment in the identified subset available to the user seeking to invest through a secure platform.

Still further, additional exemplary systems hereof comprise a computer-aided communication and investment facilitation system comprising: a means for receiving a first set of data from a plurality of entities seeking investment and a second set of data from a user seeking to invest; a means for routing the first and second sets of data to at least one storage server for storage thereon; a means for categorizing the plurality of entities into subsets based on the first set of data; a means for identifying at least one subset of entities that satisfies the second set of data; and a means for making and publishing content associated with each of the users seeking investment in the identified subset available to the user seeking to invest through a secure platform. Furthermore, in certain embodiments, the means for categorizing and the means for identifying of the aforementioned system may each comprise at least one application executed on a server.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a schematic/block diagram of an investment facilitation system, according to an exemplary embodiment of the present disclosure;

FIG. 2 shows a flow diagram of a method for accessing and/or creating content for use with the system of FIG. 1, according to exemplary embodiments of the present disclosure;

FIG. 3 shows a flow diagram of the method of FIG. 2 in connection with a method for searching and evaluating content for use with the system of FIG. 1, according to exemplary embodiments of the present disclosure; and

FIG. 4 shows a flow diagram of the methods of FIGS. 2 and 3 in connection with a method for controlling user quality for use with the system of FIG. 1, according to exemplary embodiments of the present disclosure.

An overview of the features, functions and/or configurations of the components depicted in the various figures will now be presented. It should be appreciated that not all of the features of the components of the figures are necessarily described. Some of these non-discussed features, such as various couplers, etc., as well as discussed features are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended. On the contrary, it is intended to cover alternatives, modifications, and equivalents as may be included within the spirit and scope of the invention as defined by the appended claims.

For example, the systems, methods and techniques of the present invention will be described in the context of facilitating communication between parties to ultimately achieve capital investment in a business. However, it should be noted that the systems, methods and techniques of the present invention apply in a wide variety of contexts. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

In the following description, numerous specific details are set forth in order to provide a thorough understanding of the present disclosure. Particular examples may be implemented without some or all of these specific details. In other instances, well known process operations and/or system configurations have not been described in detail so as to not unnecessarily obscure the present disclosure.

Various techniques and mechanisms of the present invention will sometimes describe a connection between two components. Words such as attached, affixed, coupled, connected, and similar terms with their inflectional morphemes are used interchangeably, unless the difference is noted or made otherwise clear from the context. These words and expressions do not necessarily signify direct connections, but include connections through mediate components and devices. It should be noted that a connection between two components does not necessarily mean a direct, unimpeded connection, as a variety of other components may reside between the two components of note. For example, a user station may be connected to a platform, but it will be appreciated that a variety of bridges and controllers may reside between the user station and the platform or a server thereof. Consequently, a connection does not necessarily mean a direct, unimpeded connection unless otherwise noted.

Furthermore, wherever feasible and convenient, like reference numerals are used in the figures and the description to refer to the same or like parts or steps. The drawings are in a simplified form and not to precise scale.

The detailed descriptions which follow are presented, at least in part, in terms of algorithms and symbolic representations of operations on data bits within a computer memory representing alphanumeric characters or other information. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be kept in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms commonly associated with mental operations performed by a human operator (such as “comparing” or “assessing”). No such capability of a human operator is necessary, or desirable in most cases, in any of the operations described herein which form part of the embodiments of the present application the operations are machine operations. Indeed, a human operator could not perform many of the machine operations described herein due to the real time or near-real time processing, networking and vast distribution capabilities of the present disclosure.

Useful machines for performing the operations of one or more embodiments hereof include general purpose digital computers, microprocessors, or other similar devices. In all cases the distinction between the method operations in operating a computer and the method of computation itself should be recognized. One or more embodiments of the present disclosure relate to methods and apparatus for operating a computer in processing electrical or other (e.g., mechanical or chemical) physical signals to generate other desired physical manifestations or signals. The computer and systems described herein operate on software modules or applications, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

In the following description, several terms which are used frequently have specialized meanings in the present context. The terms “network,” “local area network,” “LAN,” “wide area network,” or “WAN” mean two or more computers which are connected in such a manner that messages may be transmitted between the computers. In such computer networks, typically one or more computers operate as a “server,” which runs one or more applications capable of accepting requests from clients and giving responses accordingly. Servers can run on any computer including dedicated computers, which individually are also often referred to as “the server” and typically comprise—or have access to—large storage devices or storage environments (such as, for example, hard drives, virtual databases, and/or the like) and communication hardware to operate peripheral devices such as printers or modems. Servers can also be configured for cloud computing, which is Internet-based computing where groups of remote servers are networked to allow for centralized data storage. Such cloud computing systems enable users to obtain online access to computer services and/or resources.

Other computers, termed “user stations,” provide access to a user interface so that users of computer networks can access the network resources, such as shared data files, common peripheral devices, and inter-user station communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program or application that carries out one or more specific functions and may be used alone or combined with other modules of the same system or program.

The term “Browser” refers to a program which is not necessarily apparent to the user, but which is responsible for transmitting messages between a user station and the network server and for displaying and interacting with the network user. Browsers are designed to utilize a communications protocol for transmission of text and graphic information over a worldwide network of computers, namely the “World Wide Web” or simply the “Web.” Examples of Browsers compatible with one or more embodiments described in the present disclosure include, but are not limited to, the Chrome browser program developed by Google Inc. of Mountain View, Calif. (Chrome is a trademark of Google Inc.), the Safari browser program developed by Apple Inc. of Cupertino, Calif. (Safari is a registered trademark of Apple Inc.), Internet Explorer program developed by Microsoft Corporation (Internet Explorer is a trademark of Microsoft Corporation), the Opera browser program created by Opera Software ASA, the Firefox browser program distributed by the Mozilla Foundation (Firefox is a registered trademark of the Mozilla Foundation), or any other Browsers or like programs currently in use or hereinafter developed. Although the following description details operations in terms of a graphic user interface of a Browser, it will be understood that one or more embodiments disclosed in the present disclosure may be practiced with text based interfaces, voice or visually activated interfaces, or any other interfaces now or hereinafter developed that have many of the functions of a graphic based Browser.

Disclosed herein are embodiments of systems, methods and techniques for facilitating communication between one or more investors and one or more pre-qualified businesses in an effective manner. As used herein, the term “business” refers to and encompasses any entity, company, venture, individual, or group of individuals seeking capital investment, and the term “investor” refers to and encompasses any individual or firm seeking to invest capital in a business including, without limitation, venture capitalists, family offices, angel investors, and investment firms.

In general, the systems, methods and techniques disclosed herein provide a platform for businesses and investors to evaluate opportunities and interact directly in an effective, efficient and meaningful way. For example, the systems, methods and techniques hereof can provide an exclusive crowdfunding platform that enables pre-qualified businesses to display information regarding their companies and/or ventures in a secure environment that is only accessible by validated and/or accredited investors. The investors can then anonymously browse through the posted business profiles and identify and evaluate investment opportunities in an effective and efficient manner. Furthermore, once an investor identifies one or more businesses of interest, the systems, methods and techniques of the present application also enable the investor to contact such business(es) directly through a secure environment and/or enable the business to make its confidential and/or proprietary documentation available to specific investors through the system 100. Accordingly, use of the systems, methods and techniques of this disclosure is beneficial to both investors and businesses as the businesses are already pre-screened for the investors and the businesses are provided with direct and meaningful access to multiple potential investors that would otherwise be difficult to locate.

Furthermore, according to certain embodiments, the systems, methods and techniques disclosed herein comprise an investor defining a set of parameters with which a business must comply in order for such investor to consider making an investment therein. As such, the systems, methods and techniques disclosed herein further comprise automatically compiling subsets of pre-qualified businesses when such businesses' characteristics and/or capital requirements correspond with one or more investor's identified parameters. In certain embodiments, only those businesses that fall within each investor's parameters (and, thus, the identified subsets) will be accessible by the investor for review and consideration. This saves significant time and resources on both the investors' and businesses' ends.

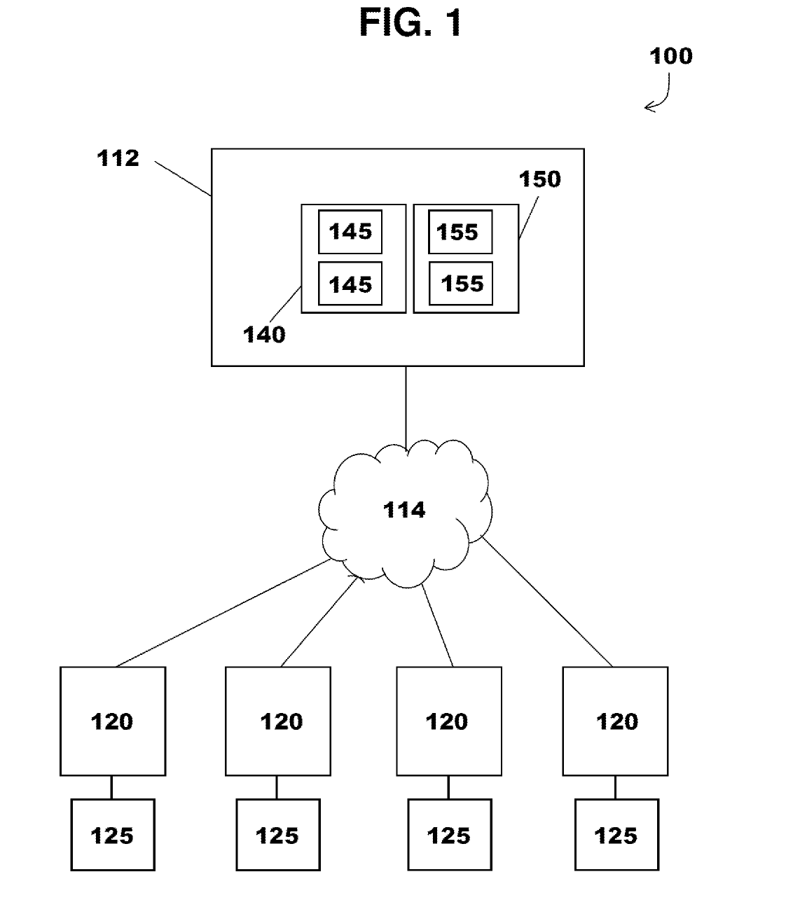

FIG. 1 shows a conceptual overview of at least one exemplary embodiment of a communication and investment facilitation system 100 through which aspects of the present invention may be implemented. As shown in FIG. 1, communication and investment facilitation system 100 permits access by and/or comprises one or more user stations 120 operably connected to, and/or in communication with, a platform 112. One or more users 125, such as investor-users and business-users (as referenced in further detail herein), can access platform 112 via the one or more user stations 120. The communication and investment facilitation system 100 is configured such that one or more users can access the particular functionality of and/or data stored within the platform 112 via a user interface (not shown) and a communication link 114. The system 100 may be configured similarly to a multi-user site in that numerous parties may register and/or access the platform 112 via multiple—and commonly remote—user stations 120.

A user station 120 may be a computer, computing device, or system of a type known in the art, such as a personal computer, mainframe computer, workstation, notebook or laptop computer or device, hand-held computer, wireless mobile telephone, personal digital assistant device and the like. Additionally, user stations 120 may each comprise any software (operational and application), hardware and componentry as would occur to one of skill in the art, such as, for example, one or more microprocessors, memory, input/output devices, device controllers, and the like. User stations 120 may also comprise one or more input devices that are operable by a user of the user station 120 such as, for example, a keyboard, keypad, pointing device, mouse, touchpad, touchscreen, microphone, and/or any other data entry means known in the art. Furthermore, user stations 120 may also comprise visual and/or audio display means for displaying or emitting output. For example, a user station 120 may comprise a CRT display, an LCD display, a printer, one or more speakers, and/or any other types of display or output devices known in the art. The exact configuration of each user station 120 in any particular implementation of a communication and investment facilitation system 100 may vary between user stations 120 and may be left to the discretion of the practitioner.

Each user station 120 is connected to, and/or in communication with, the platform 112 via a communication link 114. The communication link 114 providing access to and/or serving as part of an exemplary communication and investment facilitation system 100 of the present disclosure comprises any means for electronically interconnecting the platform 114 and a user station 120. In at least one exemplary embodiment, the communication link 114 comprises the Internet, a global computer network. Alternatively, the communication link 114 may be selected from a variety of different networks and/or cables including, but not limited to, a commercial telephone network, one or more local area networks, one or more wide area networks, one or more wireless communications networks, coaxial cable(s), fiber optic cable(s), and/or twisted-pair cable(s). Additionally, the communication link 114 may comprise equivalents of any of the aforementioned, or combinations of two or more types of networks and/or cables.

Furthermore, in at least one embodiment where the platform 112 and a user station 120 comprise a single computing device operable to perform the functions delegated to both platform 112 and a user station 120 according to the present disclosure, the communication link 114 may comprise the hardware and software means interconnecting the platform 112 and user station 120 within the single computing device. Accordingly, the communication link 114 may comprise packet-switched facilities (such as the Internet), circuit-switched facilities (such as the public-switched telephone network), radio-based facilities (such as a wireless network), or any other facilities capable of interconnecting a user station 120 with the platform 112. Additionally, the user stations 120 and/or wired/wireless connections may include the appropriate safeguards to ensure that the transmission of data between the platform 112 and each user station 120 is secure.

It will be appreciated that where the system 100 comprises a plurality of user stations 120, such stations 120 need not all comprise the same type of user station 120 or be in communication with the platform 112 via the same type of communication link 114. As such, the communication and investment facilitation system 100 may comprise some user stations 120 configured to connect to/communicate with the platform 112 via the Internet, for example, while other user stations 120 are connected to the platform 112 via a wired connection (e.g., a cable).

As described above, the communication and investment facilitation system 100 further comprises a user interface (not shown) to facilitate a user's 125 input into and access to the functionality of and/or data stored within the platform 112. The user interface can be any interface known in the art that is appropriate to achieve such a purpose and is fully customizable. For example, the display and content of the user interface may be customized for particular categories of users 125 such that the communication and investment facilitation system 100 provides standardized user interfaces having features and functionality that are specifically tailored to its different types of users' 125 needs.

The user interface may be local to a user station 120, provided over the communication link 114, or stored within the platform 112. In at least one embodiment, the user interface comprises a web-based portal that provides functionality for accessing and displaying data stored within the platform 112. In at least one exemplary embodiment, the user interface comprises a mobile application and/or widget designed to run on smartphones, tablet computers and other mobile devices.

As previously described, one or more user stations 120 can be operably connected to and/or in communication with the platform 112 of the communication and investment facilitation system 100. In general, the platform 112 supports at least two categories of “users” 125 of the system 100—investors (investor-users) and businesses seeking investment (business-users)—and is the component of the system 100 that facilitates efficient and meaningful interaction between investors and businesses. The platform may further support a third category of system 100 user—the administrator. In at least one embodiment, the system 100 is operated by (or under the control of) the administrator, which may be an individual or a business entity. For example and without limitation, an administrator may have broad security credentials that provide it with access to data stored throughout the system 100; rights to customize components, functionality and/or features of the system 100 itself; the ability to define baseline and other parameters used in prescreening and other applications; and the authority to terminate or suspend a user's 125 account.

The platform 112 is capable of multiple functionalities that may be customized according to a particular application of the system 100. As described in more detail below, the platform 112 may be configured to perform the initial screening of potential users 125, categorize business-users 125 and create focused subsets of users 125 based on general and/or investor-defined parameters, enable business-users 125 to create a promotional home page and other materials, and publish and make such promotional home pages/materials available to system users 125. Additionally, the platform 112 may also facilitate direct communication between an investor-user and targeted business-user(s) through the secure system 100.

It will be appreciated that the communication and investment facilitation system 100 may be implemented through any appropriate application architecture pattern now known or hereinafter developed. In at least one exemplary embodiment, the communication and investment facilitation system 100 is delivered through an n-tier architecture in which presentation, application/business logic, and data management functions are logically and/or physically separated. This application architecture pattern provides benefits in the way of increased availability of the system 100 to its users (i.e. reduced downtime), the minimization of the impact of any component failure, and facilitates disaster recovery. Additionally, third party applications may be interfaced with the system 100 and provided to users 125 without sacrificing data security as such third party applications need not be in direct communication with the data structures of the system 100.

Now referring to examples of such system data structures, the platform 112 comprises at least one storage server 140 for storing data and at least one computer server 150 for running one or more applications or services. The storage server 140 and the computer server 150 may consist of a single server or computing device, or comprise multiple linked servers and/or computing devices, which may be used together or singly. For example, in at least one embodiment, the at least one storage server 140 and the at least one computer server 150 comprise a plurality of servers or other computing devices or systems that are collectively operable to perform functions allocated to the platform 112 pursuant to the present disclosure. The platform 112 or one or more of the servers 140, 150 thereof may be physical, hybrid, or virtual. For example, the present invention may be delivered to users 125 as a converged infrastructure solution (either through cloud computing or otherwise), through traditional hosting, or any other means known in the art.

The storage server 140 comprises one or more databases 145 in which data that is received by the system 100 is stored. Such storage servers 140 may comprise server memory. In at least one embodiment, a storage server 140 of the system 100 comprises one or more components of solid-state electronic memory, such as random access memory. Additionally or alternatively, a storage server 140 may also comprise an electromagnetic memory such as one or more hard disk drives and/or one or more floppy disk drives or magnetic tape drives, and may comprise an optical memory such as a Compact Disk Read Only Memory (CD-ROM) drive. Furthermore, in at least one embodiment, storage server 140 may further comprise such software (operational and application), hardware and componentry as would be expected for use in connection with traditional computers.

It will be understood that the storage server 140 may comprise any number of databases 145. Furthermore, each of the one or more databases 145 may be designated to store particular types and/or formats of data, and/or configured to require specific user 125 authorization credentials such that the database 145 (or particular records stored therein) is only accessible to certain authorized users 125. For example, in at least one exemplary embodiment, the storage server 140 comprises an investor information database 145 and a business information database 145. In this embodiment, the databases 145 may be used to store data received from the respective categories of users 125 and may include confidential and/or sensitive information (e.g., the identity and contact information of high net worth investor-users 125 or confidential business information). Furthermore, any database 145 of the system 100 may be configured such that only approved users 125 are able to gain access to particular records. For example, and without limitation, an investor-user 125 may elect to remain anonymous to business-users 125 while browsing information published on or otherwise made available via the communication and investment facilitation system 100, or business-users 125 may opt to only disclose sensitive business information to particular investor-users 125. Accordingly, the format and authorization protocols of the one or more databases 145 of the storage server 140 and the individual records stored therein may be customized according to the application of the system 100 and/or users' 125 specific needs.

In addition to the storage server 140, the platform 112 further comprises the computer server 150. The computer server 150 comprises one or more applications 155 running on the platform 112. The applications 155 interact with the one or more user 125 stations and the database(s) 145 of the storage server 140 to acquire, process, display and/or transmit data received from the users 125. Additionally, one or more of the applications 155 are operable to store data in one or more databases 145 of the storage server 140 such that it may be accessed and/or utilized by the appropriate users 125 through the system 100. It will be appreciated that any number of applications 155 may be included in the computer server 150 and that the functionality of such applications 155 can be customized pursuant to the specific application of the communication and investment facilitation system 100 and/or administrator preference.

In at least one embodiment, the computer server 150 includes one or more applications 155 for prescreening potential users 125 of the communication and investment facilitation system 100. When the computer server 150 includes a prescreening application 155, potential users 125 can be screened automatically by the system 100 subject to a set of established criteria as a condition-precedent to being assigned credentials to access the communication and investment facilitation system 100. The details and extent of the prescreening can be set by the administrator to achieve a desired result and/or to restrict system 100 use to a desired demographic and/or quality of users 125. In this manner, the communication and investment facilitation system 100 can analyze a large number of users 125 and quickly and efficiently weed-out any that do not satisfy the desired criteria, thus easily identifying those that do meet the criteria.

In its simplest form, the prescreening criteria may simply consist of a request that the potential user 125 provide certain information and/or agree to Terms and Conditions related to use of the system 100. Here, after the potential user 125 provides such information (i.e. satisfies the criteria), he/she/it will be granted system 100 access. For example, each potential user 125 may be instructed to provide certain information regarding their company/venture and/or profession, and identify their field of interest and whether they desire to use the system 100 as an investor or business seeking capital. Additionally, the prescreening criteria may include having a potential user 125 provide valid payment information.

Alternatively, the prescreening process and criteria can be more comprehensive than simply requesting information or a combination of these techniques may be employed. Where a comprehensive prescreening strategy is used, the potential users' 125 responses are evaluated and measured against a predetermined standard (e.g., a response is evaluated against the standard and either passes or fails, with a certain percentage of passing responses required to gain access to the system 100). A comprehensive prescreening approach may be applied to ensure each user 125 of the system 100 has satisfied a minimum standard of viability with the resulting benefit being that the quality of users 125 on the system 100 is controlled. Accordingly, business-users 125 can be certain they are interacting with accredited investors and investor-users 125 can be certain they are evaluating validated businesses that have completed the necessary steps/legwork and are serious about raising capital.

All potential users 125 may be evaluated pursuant to the same prescreening criteria or such criteria may be tailored to each category of user 125. For example, prescreening criteria for potential business-users 125 may be specifically set to determine the eligibility and validity of the business venture. Such business-user 125 prescreening criteria may include (without limitation) that the business has completed entity formation, operates as a legal entity, has made intellectual property filings, has completed certain paperwork and/or prepared the appropriate documentation (e.g., a prospectus, business plan, executive summary, financial reports, etc.), and/or has prepared proposed initial terms for investment. Likewise, separate prescreening criteria can be used for prospective investor-users 125. An example of investor-user 125 prescreening criteria includes requiring the potential user 125 to complete and submit an investment profile to the system 100.

In addition to the prescreening applications 155, the computer server 150 may also and/or alternatively comprise one or more content applications 155 for creating content and publishing the same over the communication and investment facilitation system 100. Specifically, the content applications 155 hereof comprise tools and/or platforms through which users 125 can create and support custom home pages and other promotional materials. It will be appreciated that such home pages and promotional materials may be configured and customized in any manner and may include a variety of content including, but not limited to, text, images, audio, video, interactivity, external links, and the like. Furthermore, the content applications 155 may additionally allow a user 125 to upload documentation to the platform 112 and/or its home page to be made available through the system 100 either to all users 125 or to certain subsets of users 125 pursuant to authorization protocols (e.g., a user 125 may limit access to the documentation to only particular investor-users 125 with which it has entered into a confidentiality agreement).

Once published on the communication and investment facilitation system 100, the information and materials may be securely accessed and viewed by other users 125 of the system 100, which can be all users 125 or a subset of users 125. In at least one embodiment, users 125 can use the communication and investment facilitation system 100 to research and learn about other business-users 125 and/or investor-users 125 by browsing through and reviewing such users' 125 published home pages/materials. Accordingly, the functionality of the content application(s) 155 provides a tool through which users 125 can promote themselves and/or research potential investment opportunities through the system 100.

Specifically, using the content application(s) 155, a business-user 125 can build and customize a home page to display information relevant to its venture, as well as management profiles, product/service information, information on previous funding rounds, etc. Making such home pages, promotional materials and documentation available to investor-users 125 provides legitimacy and validation to the business-user's 125 venture and can jumpstart an interested investor-user's 125 research efforts. Additionally, in at least one embodiment, access to the published information and materials may be expanded beyond the system 100 itself. In other words, it is contemplated that, at the appropriate user's 125 request, the system 100 can make user 125 content available to interested parties outside of the communication and investment facilitation system 100.

While it is useful for users 125 to provide data and information to other users 125 over the communication and investment facilitation system 100 by way of home pages and other published materials, without further categorization, such information is not as easily searchable as it could be. Indeed, the vast amount of information in the platform 112 often prevents its effective utilization.

To address this issue and facilitate efficient use of the system 100, the computer server 150 may further comprise one or more applications 155 for categorizing users 125 into subsets of users 125 having like attributes and evaluating those attributes against parameters defined by the administrator and/or the users 125 individually. Specifically, in at least one embodiment, a categorization application 155 may categorize investor-users 125 into subsets by investor type (e.g., angel investors, family offices, venture groups, investment firms, broker/dealers, etc.). Thereafter, the identified subsets are evaluated against a user's 125 investment preferences (i.e. parameters). For example, if a business-user 125 is interested only in attracting angel investment, the categorization application 155 first categorizes investor-users 125 into subsets according to their investor type and subsequently identifies the subset that corresponds with the identified parameters (in this example, the subset comprising angel investors).

In certain embodiments of the system 100, users 125 may access all business-users' 125 home pages and promotional materials through the platform 112 at any time (unless a business-user 125 has expressly restricted access to a particular record or the like). However, according to alternative embodiments, a user's 125 access to user 125 content may be limited to only those users 125 who fall within a compatible subset. In other words, the system 100 may be configured such that an investor-user 125, for example, may only access a business-user's 125 profiles/home pages/content if such business-user 125 falls within a subset that is compatible with the investor-user's 125 defined investment parameters.

The categorization feature of the communication and investment facilitation system 100 provides a significant advantage to both investor- and business-users 125. The creation and identification of compatible user 125 subsets enables users 125 to focus their efforts on a manageable collection of data and ultimately be more efficient in identifying viable investment opportunities. For example, the categorization of business-users 125 into subsets results in investor-users 125 being able to focus their searching/vetting efforts on the most relevant business-users 125 instead of devoting valuable time to sifting through a large number of business-users 125 that fall outside such investor-user's 125 scope of search. Furthermore, if a business-user 125 will not accept a certain type of investor or seeks a specific amount of funding, these criteria can be addressed up-front and energy is not wasted in fostering a relationship between an ultimately incompatible investor and business.

In addition to the foregoing, the communication and investment facilitation system 100 may further comprise one or more communication applications 155 for supporting direct communication across the platform 112 between two users 125. Input from one user 125 may be submitted and/or transmitted through the system 100 in the form of an e-mail, instant message, text transmission, phone transmission, other written/typed correspondence, or any other form of transmission that is known in the art. Accordingly, where a user 125 identifies another user 125 of the system 100 as a viable investment opportunity, the first user 125 can contact the second user 125 directly through the system 100 to establish a relationship and potentially facilitate investment.

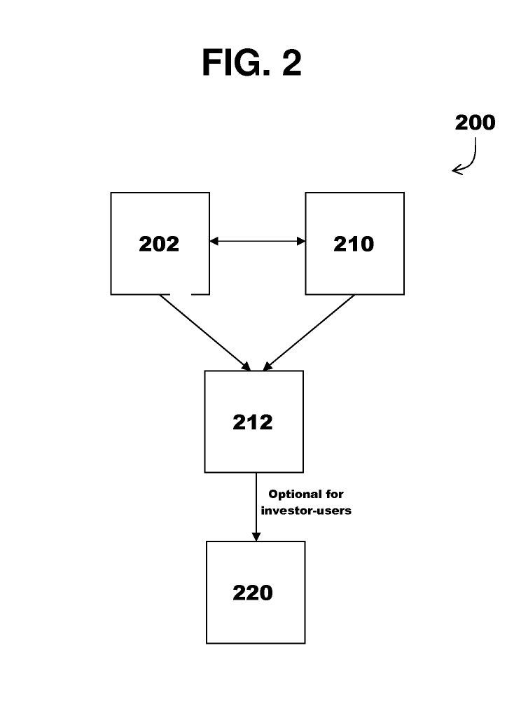

Now referring to FIGS. 2-4, flow charts of methods for facilitating communication between investors and businesses are shown as performed in accordance with one or more embodiments hereof. In some embodiments, as shown in FIGS. 2-4, techniques for facilitating communication between investors and businesses may include various operations. For the sake of clarity, the overall process described herein has been broken down into three component parts—a method 200 for accessing and/or creating content within the communication and investment facilitation system 100, a method 300 for searching content within the communication and investment facilitation system 100, and a method 400 for controlling user 125 quality. It will be appreciated that method 200 may be combined with either method 300 or 400 individually or in combination to achieve the desired results. In other words, embodiments of the overall process for facilitating communication described herein need not comprise all three methods 200, 300, 400 in combination.

FIG. 2 illustrates a flow chart of a method 200 for accessing and/or creating content within the communication and investment facilitation system 100. Upon deciding to utilize the communication and investment facilitation system 100 to facilitate communication between businesses and investors, a potential user 125 can enter the method 200 at step 202 or step 210 by providing certain information to the platform 112 via one or more user 125 stations. Thereafter, the user 125 can access the communication and investment facilitation system 100 and content thereof at step 212.

Step 202 (a step of providing investment information) and step 210 (a step of providing registration information) differ only in terms of the type of information provided by the potential user 125. For example, a potential user 125 provides its registration information at step 210, which may include (without limitation) its name, address and other contact information. An additional type of registration information that may be provided at step 210 includes, but is not limited to, payment information for covering any fees associated with use of the system 100. On the other hand, the information provided at step 202 relates more to a user's 125 desired use of the communication and investment facilitation system 100 and its parameters relating to investment.

Referring back to step 210, the type and amount of registration information provided by a potential user 125 at step 210 may be consistent across the different categories of potential users 125 (i.e. investors and businesses); however, it is contemplated that the method 200 may alternatively be configured to request different information from different categories of potential users 125 (for example, in at least one embodiment, the system 100 may request payment information from businesses, but not from investors). In at least one exemplary embodiment, step 210 additionally comprises the creation of a username and password for each user 125 as a condition precedent to accessing the platform 112 at step 212.

After, concurrently therewith, or before providing registration information at step 210, the potential user 125 may provide information at step 202 relating to its desired use of the communication and investment facilitation system 100. Such information may relate to whether or not it desires to use the communication and investment facilitation system 100 as an investor seeking an investment opportunity or as a business seeking capital. Additionally, the potential user 125 may provide information regarding the desired outcome with respect to its use of the system 100.

In at least one exemplary embodiment, the particular information the potential user 125 provides at step 202 is dependent upon the category of user 125 in which the potential user 125 falls. Where a potential user 125 is an investor, the information provided at step 202 may relate to defining the scope of an investment such potential user 125 is willing to make. For example, in addition to its general contact information, a potential investor-user 125 may provide information regarding its desired industry, upper/lower limits as to the monetary amount it is willing to invest, and other requirements relating to its investment comfort zone. Additionally, a potential investor-user 125 may be required to provide evidence with respect to validation, such as, for example, confirmation that it is an “accredited investor” appropriately registered with the United States Securities and Exchange Commission.

Likewise, where a potential user 125 is a business seeking investment, in addition to the general contact and payment information provided at step 210, the information provided at step 202 may define the parameters relating to the amount and/or type of capital sought and the conditions it is willing to accept in exchange for capital investment. The information provided at step 202 may also relate to the viability of its business. In at least one exemplary embodiment, information concerning due diligence efforts may be required such as, for example, lists of its shareholders/partners (and their respective holdings), officers and directors; identification of any agreements or other circumstances that might restrict the sale or transfer of the business; a statement certifying the business has been properly formed and operates as a valid legal entity; legal descriptions of assets; and any other information that might be requested to validate the business and its venture.

While specific examples have been provided regarding the type of information collected by the system 100 at steps 202 and 210, it will be appreciated that the communication and investment facilitation system 100 is fully customizable. Accordingly, an administrator can establish the type and amount of information requested by the communication and investment facilitation system 100 at step 202 in accordance with any particular application of the system 100 and may even tailor specific information requests to different categories of potential users 125.

Following information gathering steps 202 and 210, the method 200 progresses to step 212. At step 212 (a step of accessing system 100), the user 125 gains access to the platform 112 of the system 100 by logging on in its capacity as either a business-user 125 or an investor-user 125. In an exemplary embodiment, the user 125 may access the platform 112 at step 212 via an application 155 that prompts the user 125 to enter a username, password and/or other form of identification. Once authenticated, the user 125 is provided access to the platform 112 and the information stored thereon.

In at least one embodiment, a user's 125 access may be limited to only those databases 145, records, and/or content of the system 100 for which it has the appropriate credentials. In this manner, method 200 may provide a layer of security to the communication and investment facilitation system 100 to ensure that only authorized users 125 gain access to any sensitive or confidential information stored thereon.

Such credentials may be user 125 category specific (i.e. all investor-users 125 may have the same credentials and all business-users 125 may have the same credentials). For example, all investor-users 125 may be authorized to browse information related to any business-user 125 of the system 100 upon accessing the platform 112 at step 212, and all business-users' 125 accounts may be identically limited as to their information access. Additionally or alternatively, credentials may be assigned to each user 125 individually at registration step 210 or at some later step in the method 200. For example, with respect to the investor-user 125 anonymity, where an investor-user 125 desires to disclose its identity to one or more business-users 125, such business-users 125 can be assigned certain credentials such that they can access such information through the system 100.

Upon gaining access to the platform 112 at step 212, a user 125 can optionally proceed to create and publish content over the communication and investment facilitation system 100 at step 220. Particular useful to business-users 125, step 220 (a step of creating and publishing content) provides tools and platforms for users 125 to create and publish custom home pages and promotional materials such that the same are available over the platform 112. Accordingly, users 125 can educate other users 125 with respect to their company and/or investment goals and business-users 125 can promote their ventures in furtherance of obtaining capital investment and/or provide evidence of the businesses' validity (e.g., by uploading and making support documentation available through the platform). Investor-users 125 may also opt to create and publish content through the system 100 at step 220. However, it will be noted that, at least for investor-users 125, this step 220 is optional as investor-users 125 need not create/publish content in order to realize the full benefit of the system's 100 functionality.

The content created at step 220 may be made available to all users 125 of the communication and investment facilitation system 100 or, alternatively, accessed only by those users 125 having the proper credentials. Where content is generally available across the platform 112, any user 125 (business or investor) may search and/or access the same. In such cases, business-users 125 can view their competitions' content and investor-users 125 can browse all available investment opportunities. Alternatively, as previously described, a user 125 may specify that certain security protocols be associated with all or some of their published content, thereby limiting which users 125 can access the same (e.g., limit access only to investor-users 125 or to only particular users 125 with whom it has entered into a confidentiality or nondisclosure agreement).

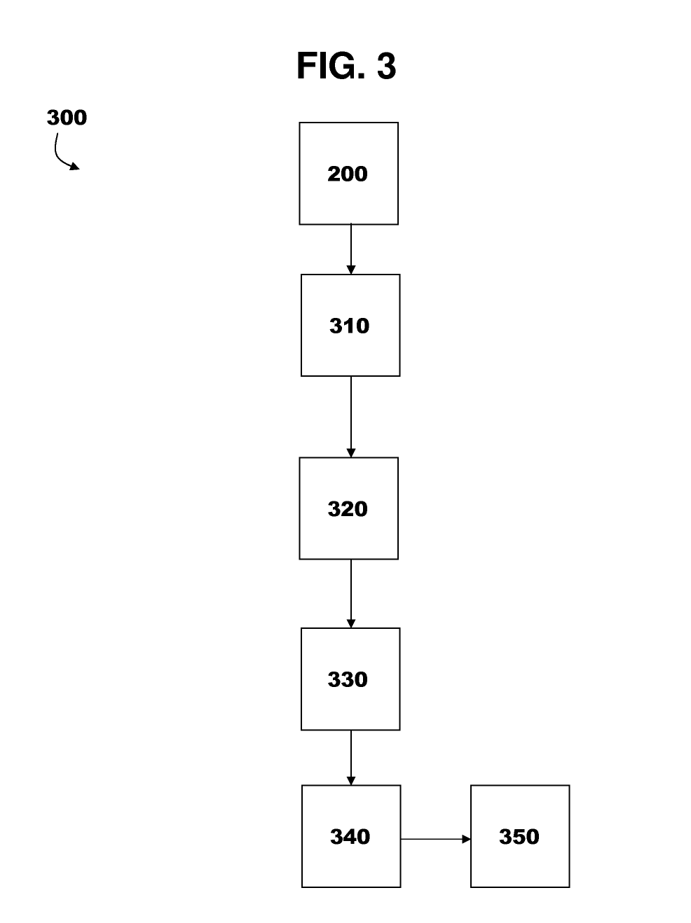

Now referring to FIG. 3, a flow chart illustrates a second component of a method for facilitating communication between investors and businesses. Specifically, this component comprises a method 300 for searching and evaluating content within the communication and investment facilitation system 100. This portion of the process facilitates a user's 125 meaningful use of the communication and investment facilitation system 100 by not only leveraging the network-based configuration of the system 100 to obtain an aggregate and comprehensive view of content published thereon, but b also providing a means to effectively and efficiently sort through and interpret the large amount of information that can be stored within the platform 112. Specifically, through use of the method 300, an investor-user 125 can easily identify and focus its efforts on those business-users 125 it considers to have the highest potential for investment.

As shown in FIG. 3, at step 310 (a user categorization step), one or more categories are created and assigned based on the information collected in steps 202, 210 and/or 220 of method 200. As previously described in detail, a category may correspond to a particular range of capital sought (e.g., <$1M, $1M-$5M, >$5M). Additionally or alternatively, a category may be identified as the field/industry in which a user 125 operates. Accordingly, in an illustrative embodiment of the aforementioned examples, at step 310 the method 300 organizes the information received from the users 125 in method 200 into the six categories as set forth in Table 1 below.

TABLE 1
Categories

| Amount of Investment Sought | Industry |
|---|---|
| Category #1: <$1M | Category #4: Healthcare |
| Category #2: $1M-$5M | Category #5: Information technology |
| Category #3: >$5M | Category #6: Textiles |

It will be appreciated that, based on the information supplied in steps 202, 210 and/or 220 of method 200, a single user 125 may fall into several different categories. For example, with respect to the example described in Table 1 above, a user 125 may be assigned to both Category #1 and Category #4 in the event it is in the healthcare industry seeking less than one million dollars (<$1M) in funding. It will also be appreciated that any number of categories may be employed in classifying the information supplied in steps 202, 210 and/or 220 of the method 200, and the number and type of categories employed may be established on a case-by-case basis according to a particular application of the system 100 and/or administrator preference.

After the categories are established and the information is categorized in step 310, the method 300 advances to step 320. At step 320 (a categorization evaluation step), the categories established in step 310 are evaluated relative to an investor-user's 125 identified parameters, thereby transforming a portion of the information stored on the platform 112 into a relevant and usable subset of information. In at least one embodiment, the user-specific parameters defined in step 202 of method 200 are converted into database queries that retrieve records having the appropriate categorization from one or more databases 145 of the platform 112. This effectively creates a subset of records, all of which are relevant to that particular investor-user 125.

For example, in conjunction with step 202, an investor-user 125 may have defined one or more industries in which it prefers to invest (i.e. industry type is the parameter at issue). Accordingly, at step 320, the categories of information categorized in step 310 are evaluated relative to industry type to identify those business-users 125 that operate within the desired industry. As such, step 320 identifies a subset of all business-users 125 that satisfy the investor-user's 125 identified parameter. While user 125 parameters are typically defined at step 202 of method 200, it will be appreciated that a user 125 may define and/or modify its parameters at any point during the process described herein.

Multiple parameters may also be considered in defining a subset of users 125. For example, instead of evaluating a single parameter as described in connection with the non-limiting example set forth above, step 320 may consider numerous parameters concurrently (e.g., those business-users 125 requesting less than $1M and operating in the healthcare industry). For example, in at least one embodiment, an investor-user 125 may be interested in businesses with the following parameters: 1) operating in the healthcare industry; 2) located in the Midwest; 3) seeking between $1M-$5M; and 4) having at least one patent application pending. In this example, at step 320, the method 300 evaluates the categories of information stored in the platform 112 with respect to all of the identified parameters, thereby resulting in a subset, or list, of those business-users 125 that satisfy all four criteria.

While the above-described examples identify targeted subsets based on one and four parameters, it will be appreciated that any number of parameters may be evaluated in step 320. However, the more parameters evaluated, the smaller the resulting subset. Accordingly, a user 125 can manipulate the size of its subsets by increasing or decreasing the number of parameters considered. For example, where a user 125 desires to obtain a general overview of companies seeking investment in a general area, less parameters may be employed; however, where a more narrow field is desired such that an investor-user 125 can focus its research and vetting efforts, more parameters may be evaluated at a single time.

Accordingly, the output of step 320 is a subset containing at least one record. In the event the parameters used at step 320 do not yield even a single record, the method 300 may repeat step 320 until a sufficiently large subset is identified. For example, if an investor-user 125 defines three parameters at step 202 and step 320 yields no results, the user 125 may modify the parameters and step 320 will be repeated, with this cycle continuing until the subset contains at least one hit. When a subset has been identified that contains at least one hit, the method 300 can advance to step 330.

At step 330 (an investor-user access step), the investor-user 125 accesses the information stored on the platform 112 that corresponds with the records identified in the subset at step 320 and, based on that research, selects one or more business-users 125 for investment (each, a “targeted business”). For example, where Company A, Company B and Company C have been identified in step 320 as comprising the subset, at step 330, the investor-users 125 access such business-users' 125 home pages and documentation through the platform 112 to perform further research and evaluate the potential of each targeted business. Following such research, the investor-user 125 selects at least one of the targeted businesses to pursue as an investment opportunity.

At step 340 (an investor-user communication step), the investor-user 125 communicates across the platform 112 directly with the targeted businesses. For example, in at least one embodiment, one or more communication applications 155 of the computer server 150 enable the user 125 to submit a notification of interest and/or a request for more information to the platform 112 for delivery to the appropriate business-user 125 (i.e. the targeted business). As previously described, this communication may be submitted and/or transmitted in the form of an e-mail, instant message, or any other form of transmission known in the art. At this step 340, the investor-user 125 is no longer anonymous to the targeted business and the targeted business may view the investor-user's 125 profile over the platform 112. Furthermore, in the event the targeted business has credentials or access control in place with respect to some of its confidential and/or proprietary records/files stored on the platform 112, the targeted business can opt to grant such investor-user 125 access to the same in furtherance of their ongoing discussions and negotiations. Upon completion of the negotiation process, the method 300 advances to step 350 (a discussion and negotiation step) and the parties enter into an investment agreement.

In at least one embodiment of the present disclosure, two or more investor-users 125 may be matched to one another within system 100 and decide to invest in a potential business-user 125 together. In such an embodiment, various steps herein may be performed so that two or more investor-users 125 can learn about a business-user's 125 investment opportunity and then decide to invest together. For example, an exemplary investor-user access step 330 may comprise access of multiple user-investors 125 to information stored on the platform 112 in connection with one or more business-users 125 for investment. Furthermore, investor-user communication step 340 may include two or more the investor-user's 125 that wish to communicate across the platform 112 directly with the targeted businesses, which may lead to discussion and negotiation step 350 and ultimately an investment agreement.

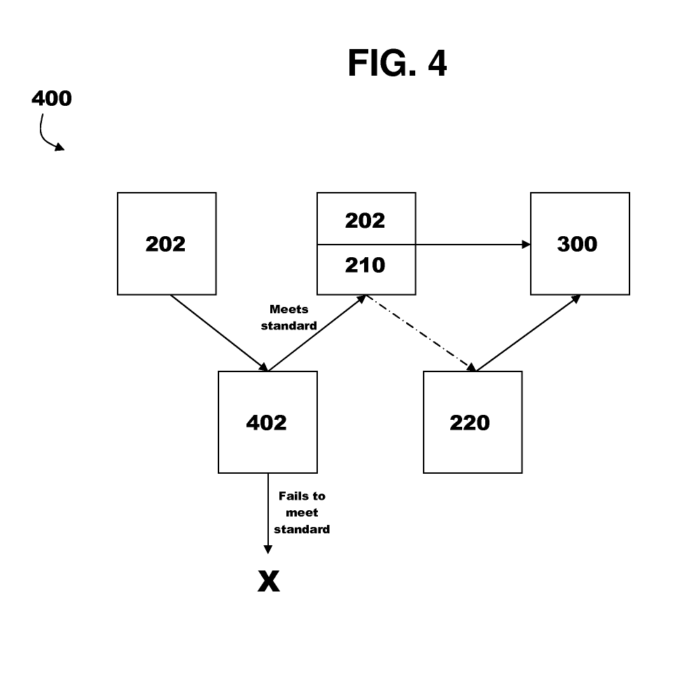

In at least one exemplary embodiment, methods 200 and 300 further comprise a method 400 for controlling user 125 quality. As shown in the flow chart of FIG. 4, method 400 comprises additional step 402 (a prescreening step), which in at least one embodiment follows after step 202 of method 200. Step 402 comprises a prescreening decision point, where it is determined if the potential user 125 satisfies certain criteria. Accordingly, an administrator can use the prescreening criteria of step 402 to validate potential users 125 of the system 100 and, thus, maintain control of the quality of those allowed to access and use the communication and investment facilitation system 100. In this manner, approved business-users 125 can be certain they are interacting with accredited investors and approved investor-users 125 can be certain they are evaluating validated businesses that have completed the necessary legwork and are serious about raising capital.

In addition, the present disclosure also includes disclosure of using a reverse auction-style capital raise, which would allow investor-users 125 to set a price based upon an offering by a business-user 125. Investor-users 125 may have an initial price target in mind, a field or fields of investment in mind, or a combination of the same, and utilize system 100 to seek information from business-users 125 who would be willing to negotiate and deal with investor-users 125 with one or more prices in mind.

Specifically, at step 402 the information a potential user 125 provided at step 202 is assessed against a set of established criteria. As previously described in detail, such criteria may be as simple as requiring each potential user 125 to provide the information required at steps 202, 210 and/or agreeing to certain Terms and Conditions with respect to their use of the system 100. Alternatively or in combination, the prescreening criteria can be comprehensive such that the content of the potential users' 125 responses is evaluated and measured against a predetermined standard. It will be appreciated that any type, number or combination of prescreening criteria may be established, and two non-limiting examples of such are as follows: 1) requiring that an investor is accredited with the Securities and Exchange Commission; and 2) requiring that a business seeking investment can provide certain due diligence documents for verification. Depending on the information a potential users 125 provides at step 202, such potential user 125 will either satisfy the standard and, thus, progress to steps 210 and 212 for registration and access to the system 100, or fail. If the standard is not met, the potential user 125 does not qualify for registration at step 210 and will be denied access to the system 100.

Specific embodiments of the inventive process hereof will now be described by way of example with reference to the accompanying system block diagram of FIG. 1 and the flow charts of FIGS. 2-4.

### EXAMPLE 1

### Investor-User

Referring to FIG. 1, an investor desires to access and use the communication and investment facilitation system 100. The investor/potential user 125 accesses the platform 112 via a user station 120 and communication link 114, and is presented with a user interface configured to receive answers to a series of questions (step 202 of method 200). At least one of the questions requests the potential user 125 to indicate its user type (i.e. investor or business seeking investment). Upon submitting its response, the investor/potential user 125 is prompted to complete an investment profile that meets certain parameters of the system 100.

Where the communication and investment facilitation system 100 comprises a prescreening functionality, the information the potential user 125 supplies in connection with the investment profile is evaluated against a set of established criteria (step 402 of method 400). Assuming the potential investor satisfies the criteria, it is then considered an investor-user 125 of the system 100 and thus is prompted to provide general registration/profile information and establish a username and password (step 210 of method 200). The investor may then access the platform 112 functionality as an investor-user 125 (step 212) and may optionally create and publish content through the platform 112 (optional step 220 of method 200). It should be noted that creating and publishing content is optional for investor-users 125 and may be completed at the investor-user's 125 discretion. Furthermore, unless otherwise desired, the investor-user's 125 identity remains confidential and is not made available to the other users 125 of the system 100 without the investor-user's 125 prior consent.

Upon gaining access to the communication and investment facilitation system 100, the investor-user 125 can browse business-user 125 content and any investor-user 125 content for which it has the appropriate credentials. To facilitate the investor-user's 125 quick and efficient access to relevant information, the communication and investment facilitation system 100 efficiently sorts through and separates out those business-users' 125 profiles/content that do not align with the parameters the investor-user 125 defined in its investment profile (steps 310 and 312 of method 300). Accordingly, the investor-user 125 is presented with a relevant subset of business-user 125 content, which allows the investor-user 125 to focus its search efforts on those business-users 125 in which it has the highest potential for investing (step 330 of method 300).

When the investor-user 125 identifies a targeted business from the subset in which it is interested in investing, the investor-user 125 can contact such targeted business using the platform 112 and the communication application 155 thereof (step 340). At the point of contact, the investor-user 125 is no longer anonymous to the targeted business and instead is identified by name. Furthermore, once the investor-user 125 initiates contact with a targeted business, the targeted business can grant the investor-user 125 private access to its confidential company documents through the secure platform 112 to further facilitate the investor-user's 125 research and validation efforts.

Accordingly, the systems and methods disclosed herein provide an efficient platform preferable to investors because the participating business-users 125 are already prescreened and the investors can be exposed to an extremely large number of quality business offerings. Furthermore, the inventive systems and methods hereof save investor-users 125 significant time and resources in sorting through available business-users 125 due to the system's categorization and sorting functionality.

### EXAMPLE 2

### Business-User

Referring back to FIG. 1, a business seeking investment desires to access and use the communication and investment facilitation system 100. The business/potential user 125 accesses the platform 112 via a user station 120 and communication link 114, and is presented with a user interface configured to receive answers to a series of questions (step 202 of method 200). At least one of the questions requests the potential business-user 125 to indicate its user 125 type (i.e. investor or business seeking investment). Upon submitting its response, the potential business-user 125 is prompted to provide certain due diligence documents and complete a due diligence checklist that meets certain system parameters. The checklist may include information regarding its business assets, contracts, employees, intellectual property, insurance, litigation, licenses, and the like.

Where the communication and investment facilitation system 100 comprises a prescreening functionality, the documents and information provided by the potential business-user 125 is evaluated against a set of established criteria (step 402 of method 400). Assuming the information is sufficient, the business is considered a business-user 125 of the system 100 and thus prompted to provide general registration/profile information, payment information, and to establish a username and password (step 210 of method 200). Accordingly, the business is granted access to the platform 112 as a business-user 125 (step 212).

Upon receiving access to the platform 112, the business-user 125 creates and publishes content through the platform 112, such as a home page and/or promotional materials (step 220 of method 200). Such home page and materials may include documents, management profiles, videos and the like and is made available to investor-users 125 through the system 100 (unless the business-user 125 desires to restrict access to the content or parts thereof). It is the business-users' 125 published content that investor-users 125 will review when researching and considering business-users 125 for investment.

To promote a business-user's 125 exposure to the appropriate investor-users 125, the communication and investment facilitation system 100 efficiently categorizes the business-user's 125 profile and makes its content available to those investor-users 125 seeking to invest in a company having corresponding parameters (steps 310 and 312 of method 300). Accordingly, the business-user 125 is included in investor-user 125 subsets when it matches such investor-users' 125 desired criteria such that the investor-users 125 can easily identify the business-user 125 and perform a more in-depth examination thereof (step 330 of method 300).

If and when an investor-user 125 identifies the business-user 125 as a targeted business, the business-user 125 may be contacted through the system 100 by the interested investor-user 125 (step 340). At the point of contact, the investor-user 125 is no longer anonymous to the business-user 125 and instead is identified by name. As such, the business-user 125 may then access such investor-user's 125 profile and perform its own due diligence and research. Furthermore, the business-user 125 can also, at its discretion, grant the investor-user 125 private access to its confidential company documents through the secure platform 112 to further facilitate the investor-user's 125 research and validation efforts.

Accordingly, the systems and methods disclosed herein provide an efficient platform preferable to business-users 125 because the platform provides the businesses with a fundraising platform with access to prescreened and vetted investors. Indeed, use of the systems and methods hereof provides business-users with exposure to validated investors that would otherwise be extremely difficult and costly (both monetarily and in terms of resources) for such businesses to achieve on their own.

While various embodiments of the investment facilitation system and methods of using the same have been described in considerable detail herein, the embodiments are merely offered as non-limiting examples of the disclosure. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A computer-aided communication and investment facilitation system comprising:
a platform comprising memory coupled with at least one server, the at least one server comprising at least one application capable of interacting with data stored at least partially in the memory of the platform; and
at least one input device in communication with the platform, each of the at least one input devices configured to receive data from a user;
wherein one or more of the applications categorizes a plurality of users into at least two subsets pursuant to at least one attribute, evaluates the subsets against a set of parameters, and identifies a targeted subset that satisfies the set of parameters.

2. The computer-aided communication and investment facilitation system of claim 1, wherein the at least one input device is in communication with the platform via a communication link and the platform comprises an exclusive crowdfunding platform.

3. The computer-aided communication and investment facilitation system of claim 1, further comprising at least one user interface in communication with the platform, the at least one user interface configured for accessing and displaying the data stored at least partially in the memory of the platform.

4. The computer-aided communication and investment facilitation system of claim 1, wherein one or more of the at least one applications is configured to evaluate each of the plurality of users against a set of criteria pursuant to a pass/fail standard and a user failing to satisfy the pass/fail standard results in denial of access to the platform for such user.

5. The computer-aided communication and investment facilitation system of claim 4, wherein the user comprises a business seeking capital investment and the set of criteria comprises a due diligence checklist.

6. The computer-aided communication and investment facilitation system of claim 1, wherein each user is either an investor or a business seeking capital investment.

7. The computer-aided communication and investment facilitation system of claim 1, wherein one or more of the at least one applications comprises tools usable to create and publish content accessible by a user through the platform, and the content is selected from a group consisting of text, images, audio files, video files, interactivity, and external links.

8. A method for facilitating communication and investment between two or more parties, the method comprising the steps of:
providing a platform comprising:
memory coupled with at least one server, the at least one server comprising at least one application capable of interacting with data stored at least partially in the memory of the platform, and
at least one input device in communication with the platform, each of the at least one input devices configured to receive data from a user,
wherein one or more of the applications is configured to categorize a plurality of users into at least two subsets pursuant to at least one attribute, evaluate the subsets against a set of parameters, and identify a targeted subset that satisfies the set of parameters;
receiving, on the platform, a first set of data from a plurality of users seeking investment and a second set of parameter data from at least one user seeking to invest;
routing the first set of data and the second set of parameter data to at least one storage server in communication with the platform for storage thereon;
categorizing the plurality of users seeking investment into one or more subsets based on the first set of data through operation of at least one application of the server;
identifying at least one subset of users seeking investment that satisfies the second set of parameter data; and
making content associated with each of the users seeking investment in the identified subset available via the platform to the user seeking to invest.

9. The method of claim 8, wherein the first set of data comprises attribute data from each of the users seeking investment.

10. The method of claim 8, wherein the content comprises attribute data associated with each of the users seeking investment in the identified subset.

11. The method of claim 10, further comprising the steps of:
identifying a targeted user within the identified subset through operation of at least one application of the platform; and
facilitating communication between the targeted user and the user seeking to invest through a secure module of the platform.

12. The method of claim 11, further comprising the step of executing an investment agreement between the targeted user and the at least one user seeking to invest via the platform.

13. The method of claim 8, further comprising the step of evaluating each of the users seeking investment and the user seeking to invest against at least one set of prescreening criteria through operation of at least one application of the server.

14. The method of claim 8, further comprising the step of using an application of the server to create and publish content for each of the users seeking investment, wherein the content is selected from a group consisting of a personalized home page, promotional materials, and business documentation.

15. The method of claim 8, wherein the platform is configured to withhold the identity of the at least one user seeking to invest with respect to the users seeking investment unless and until each user seeking to invest chooses to disclose its identity.

16. The method of claim 12, wherein the at least one user seeking to invest may comprise at least a first user seeking to invest and a second user seeking to invest and the step of executing an investment agreement between the targeted user and the at least one user seeking to invest via the platform further comprises executing a first agreement between the targeted user and a first user seeking to invest and executing a second agreement between the targeted user and the second user seeking to invest.

17. The method of claim 11, wherein two or more users seeking to invest identify the targeted user and facilitate communication with the targeted user via the platform.

18. The method of claim 12, wherein the at least one user seeking to invest seeks to invest using a reverse auction-style capital raise, and wherein the at least one user seeking to invest sets one or more prices based upon one or more offerings from one or more users seeking investment.

19. A computer-aided communication and investment facilitation system comprising:
a means for receiving a first set of data from a plurality of entities seeking investment and a second set of data from a user seeking to invest;
a means for routing the first and second sets of data to at least one storage server for storage thereon;
a means for categorizing the plurality of entities into subsets based on the first set of data;
a means for identifying at least one subset of entities that satisfies the second set of data; and
a means for making and publishing content associated with each of the users seeking investment in the identified subset available to the user seeking to invest through a secure platform.

20. The computer-aided communication and investment facilitation system of claim 19, wherein the means for categorizing and the means for identifying each comprise at least one application executed on a server.
